(19) United States
(12) Patent Application Publication
(10) Pub. No.: US 2010/0303440 A1
(43) Pub. Date: Dec. 2, 2010

(54) METHOD AND APPARATUS FOR SIMULTANEOUSLY PLAYING A MEDIA PROGRAM AND AN ARBITRARILY CHOSEN SEEK PREVIEW FRAME

(75) Inventors: Andrew Cheng-min Lin, Los Angeles, CA (US); Daniel Honig Bear, Santa Monica, CA (US); Robert Masao Wong, Santa Monica, CA (US); Charles Barclay Reeves, Los Angeles, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: HULU LLC, Los Angeles, CA (US)

(21) Appl. No.: 12/472,953

(22) Filed: May 27, 2009

(51) Int. Cl. H04N 5/91; H04N 7/173

(52) U.S. Cl. 386/241; 725/118

(57) ABSTRACT

A method, apparatus, article of manufacture, and a memory structure for playing a media program and providing a preview frame of the media program in response to a seek command is disclosed. In one embodiment, the method comprises the steps of accepting a seek command in the user computer; generating a seek request from the seek command, the seek request including information identifying an arbitrarily chosen seek preview media program frame associated with the media program; retrieving the arbitrarily chosen seek preview media program frame; and rendering the received arbitrarily chosen seek preview media program frame in the playback component of the MPP.

### BACKGROUND OF THE INVENTION

1. Field of the Invention

The present invention relates to systems and methods for providing programming guides to users, and in particular, to a system and method for providing a program guide having search parameter-aware thumbnails.

2. Description of the Related Art

The dissemination and playback of media programs has undergone substantial changes in the past decade. Previously, media programs were disseminated either by analog broadcast (conventional, satellite, or cable) or by dissemination of films to movie theaters.

These traditional dissemination and playback means remain in use after the advent of digital technology. However, digital technologies have had a profound effect on the dissemination and playback of media programs.

First, digital technology permitted the use of digital video recorders (DVRs). DVRs, while similar in function to standard analog video cassette recorders (VCRs), provide a number of additional useful functions including live pause, the ability to record one program while playing back another, and the integration of the electronic program guides with DVR functionality (so that the recordation of media programs could be scheduled far in advance).

Second, technology also permitted the dissemination and playback of media programs via the Internet, and with improved signal processing and more and more households with high-speed Internet access (e.g. DSL, fiber, satellite), this method of dissemination and playback has become competitive with traditional means. Dissemination of media programs via the Internet may occur either by simple downloading, progressive downloading or streaming.

For progressive download, a media file having the media program is downloaded via the Internet using dial-up, DSL, ADSL, cable, T1, or other high speed internet connections. Typically, the downloading is performed by a web server. Simple downloading downloads the bytes of the media file in any convenient order, while progressive download downloads bytes at the beginning of a file and continues downloading the file sequentially and consecutively until the last byte. At any particular time during progressive downloading, portions of the file are not immediately available for playback. In some situations, the entire file must be downloaded first before a media player can start playback. In other situations, media players are able to start playback once enough of the beginning of the file has downloaded, however, the media player must download enough information to support some form of playback before playback can occur. Playback is often delayed by slow Internet connections and is also often choppy and/or contains a high likelihood of stopping after only a few seconds. Downloaded material is thereafter stored on the end-user computer.

One of the disadvantages of a progressive downloading is that the entity transmitting the data (the web server) simply pushes the data to the client as fast as possible. It may appear to be “streaming” the video because the progressive download capability of many media players allows playback as soon as an adequate amount of data has been downloaded. However, the user cannot fast-forward to the end of the file until the entire file has been delivered by the web server. Another disadvantage with progressive downloading is that the web server does not make allowances for the data rate of the video file. Hence if the network bandwidth is lower than the data rate required by the video file, the user will have to wait a period of time before playback can begin. If playback speed exceeds the data transfer speed, playback may be paused for a period of time while additional data is downloaded. However, the video playback quality will be higher when the playback occurs because of the higher data rate. For example, if a 100 kbps video file can be delivered over a 56 kbps modem, the video will be presented at the 100 kbps rate, but there may be periods when playback will be paused while additional video data is downloaded. The video data is typically downloaded as a temporary file in its entirety.

Web servers use HTTP (hypertext transport protocol) on top of TCP (transfer control protocol) to transfer files over the network. TCP, which controls the transport of data packets over the network, is optimized for guaranteed delivery of data, not speed. Therefore, if a browser senses that data is missing, a resend request will be issued and the data will be resent. In networks with high delivery errors, resend requests may consume a large amount of bandwidth. Since TCP is not designed for efficient delivery of adequate data or bandwidth control (but rather guaranteed delivery of all data), it is not preferred for the delivery of video data in all applications.

Streaming delivers media content continuously to a media player and media playback occurs simultaneously. The end-user is capable of playing the media immediately upon delivery by the content provider. Traditional streaming techniques originate from a single provider delivering a stream of data to a set of end-users. High bandwidths and central processing unit (CPU) power are required to deliver a single stream to a large audience, and the required bandwidth of the provider increases as the number of end-users increases.

Unlike progressive downloading, streaming media is delivered on-demand or live. Wherein progressive download requires downloading the entire file or downloading enough of the entire file to start playback at the beginning, streaming enables immediate playback at any point within the file. End-users may skip through the media file to start playback or change playback to any point in the media file. Hence, the end-user does not need to wait for the file to progressively download. Typically, streaming media is typically delivered from one or more dedicated streaming media servers.

A streaming media server is a specialized device that accepts requests for video files, and with information about the format, bandwidth and structure of those files, delivers just the amount of data necessary to play the video, at the rate needed to play it. Streaming media servers may also account for the transmission bandwidth and capabilities of the media player. Unlike the web server, the streaming media sever communicates with the media server using control messages and data messages to adjust to changing network conditions as the video is played. These control messages can include trick play functions such as fast forward, fast reverse, pausing, or seeking to a particular part of the file. Since a streaming media server transmits video data only as needed and at the rate that is needed, precise control over the number of streams served can be maintained. Unlike the case with progressive downloading, the viewer will not be able to view high data rate videos over a lower data rate transmission medium. However, streaming media servers (1) provide users random access to the video file, (2) allows monitoring of who is viewing what video programs and how long they are watched (3) use transmission bandwidth more efficiently, since only the amount of data required to support the viewing experience is transmitted, and (4) the video file is not stored in the viewer's computer, but discarded by the media player, thus allowing more control over the content.

Streaming media servers may use HTTP and TCP to deliver video streams, but generally use RSTP (real time streaming protocol) and UDP (user datagram protocol). These protocols permit control messages and save bandwidth by reducing overhead. Unlike TCP, when data is dropped during transmission, UDP does not transmit resent requests. Instead, the server continues to send data. Streaming media servers can also deliver live webcasts and can multicast, which allows more than one client to tune into a single stream, thus saving bandwidth.

Typically, progressively downloaded media is transmitted to the user computer at a rate that is faster than playback. The media program player buffers this data, and may indicate how much of the media program has been buffered by providing an indicator, usually as a part of a “progress bar.” A control is often provided that allows the user to go to any point in the program that has already been buffered by selecting the control and moving it to a different location along the progress bar. This allows the user to randomly access any buffered portion of the media program.

Streaming media players do not rely on buffering to provide random access to any point in the media program. Instead, this is accomplished through the use of control messages transmitted from the media player to the streaming media server.

However, whether for streaming media or for progressively downloaded media, current media program players do not assist in finding a particular scene of interest when using this random access feature. Instead, the user must use the control to move the media program playback to the desired location, and resume playback to view the media program from that point forward. There are a number of disadvantages with this interface. First, this interface does not allow the user to scan forward to find another point in the media program without pausing or stopping playback of the media program from it's current location. And second, this interface loses the viewer's “place” in the media program. That is, if the viewer moves forward to search for a different scene or point in the media program, they cannot be assured of returning to the same point in the media program from where they began.

What is needed is a method and apparatus that allows the user to randomly preview any frame in the media program without interrupting or otherwise disturbing the playback of the media program. The present invention satisfies this need.

### SUMMARY OF THE INVENTION

To address the requirements described above, the present invention discloses a method, apparatus, article of manufacture, and a memory structure for playing a media program and providing a preview frame of the media program in response to a seek command. In one embodiment, the method comprises the steps of transmitting a request for the media program from a user computer to a media server; receiving the media program from the media server in the user computer, the media program having a plurality of media program frames indexed by a plurality of media program time codes; rendering (or playing) the media program in a media program player (MPP) implemented by the user computer; accepting a seek command in the user computer; generating a seek request from the seek command, the seek request including information identifying an arbitrarily chosen seek preview media program frame associated with the media program; retrieving the arbitrarily chosen seek preview media program frame; and rendering the received arbitrarily chosen seek preview media program frame in the playback component of the MPP.

In another embodiment, the invention is evidenced by an apparatus for playing a media program and providing a preview frame of the media program in response to a seek command, in which the apparatus comprises a user computer and a media program player wherein the user computer includes a communications module communicatively coupled to an MPP, the communications module for transmitting a request for the media program from a user computer to a media server and receiving the media program from the media server in the user computer, the media program having a plurality of media program frames indexed by a plurality of media program time codes, and in which the MPP is configured for rendering the media program; accepting a seek command in the user computer; generating a seek request from the seek command, the seek request including information identifying an arbitrarily chosen seek preview media program frame associated with the media program; retrieving the arbitrarily chosen seek preview media program frame; and rendering the received arbitrarily chosen seek preview media program frame in the playback component of the MPP.

### BRIEF DESCRIPTION OF THE DRAWINGS

Referring now to the drawings in which like reference numbers represent corresponding parts throughout:

FIG. 1 is a diagram illustrating an exemplary media program distribution system;

FIG. 2 illustrates an exemplary computer system that could be used to implement elements the present invention;

FIGS. 3A and 3B are diagrams presenting flowcharts illustrating exemplary operations that can be used to perform one embodiment of the invention;

FIG. 4 is a diagram illustrating an exemplary user interface presenting the MPP on the display;

FIG. 5 is a diagram illustrating the exemplary user interface after the user has moved the control of the progress bar to a second position temporally forward from the first position shown in FIG. 4;

FIG. 6 is a diagram illustrating the media program and the seek preview version of the media program;

FIG. 7 is a diagram illustrating the exemplary user interface after the user has entered a stop seek command by releasing the mouse button;

FIGS. 8A and 8B is a flowchart depicting another embodiment of the present invention; and

FIGS. 9A and 9B are diagrams depicting a flowchart of still another embodiment of the present invention.

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

In the following description, reference is made to the accompanying drawings which form a part hereof, and which is shown, by way of illustration, several embodiments of the present invention. It is understood that other embodiments may be utilized and structural changes may be made without departing from the scope of the present invention.

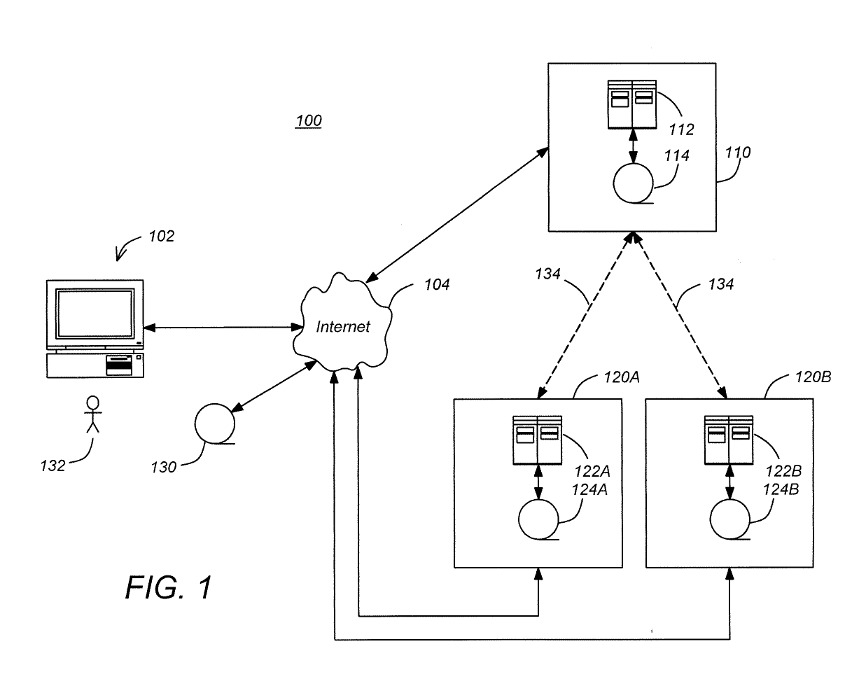

FIG. 1 is a diagram illustrating an exemplary media program distribution system 100. In the illustrated embodiment, the system 100 comprises a one or more media program sources 120A, 120B, communicatively coupled to a communication network 104 such as the Internet and each having one or more source video servers 122A, 122B communicatively coupled to one or more source media program databases 124A, 124B. The media program system 100 further comprises and a media program provider 110, communicatively coupled to the communication network 104, and having one or more provider media servers 112 and a provider media program database 114. In one embodiment, the media program provider 110 is a video-on-demand and/or streaming media program provider.

The media program system 100 may transmit (by streaming or progressive downloading) media programs to the user's computer 102 directly from the media program provider 110, or the media program provider 110 may operate as a portal, providing an interface to the media programs available from the media program sources 120A and 120B, but not the media program itself (which is instead provided by the media program source 120).

In the first case, the media program provider licenses media programs from the media program sources 120 (such as www.fox.com or www.nbc.com), and metadata for such programs is also typically provided as well. Such metadata is typically adequate (e.g. it need not be supplemented by information from other sources) and can be retrieved by the media program provider's database 114 for use.

In the second case (e.g. when direct transmission is not licensed), the media programs are transmitted to the user's computer 102 directly from the media servers of the media program source 120. When the media program is transmitted directly from the media program source 120, it is often the case that the metadata provided by the media program source 120 is insufficient. In such cases, supplementary metadata may be obtained from independent media program source 130 (such as www.tv.com or www.imdb.com) or other third party sources. In this circumstance, the role of the media program provider 110 is that of a portal that provides users a list of available media programs and an interface to search to find such programs and to view them.

Media programs and metadata may be obtained via the communication network 104 or through auxiliary (and/or dedicated) communication links 134 by webcrawling (for example, using a program or automated script that browses the World Wide Web in a methodical, automated manner).

Using the computer 102, remote users 132 can communicate with the media program provider 110, to obtain media programs (including video-on-demand progressive download, and/or streaming video services) and to search the provider media program database 114 to find media programs of interest.

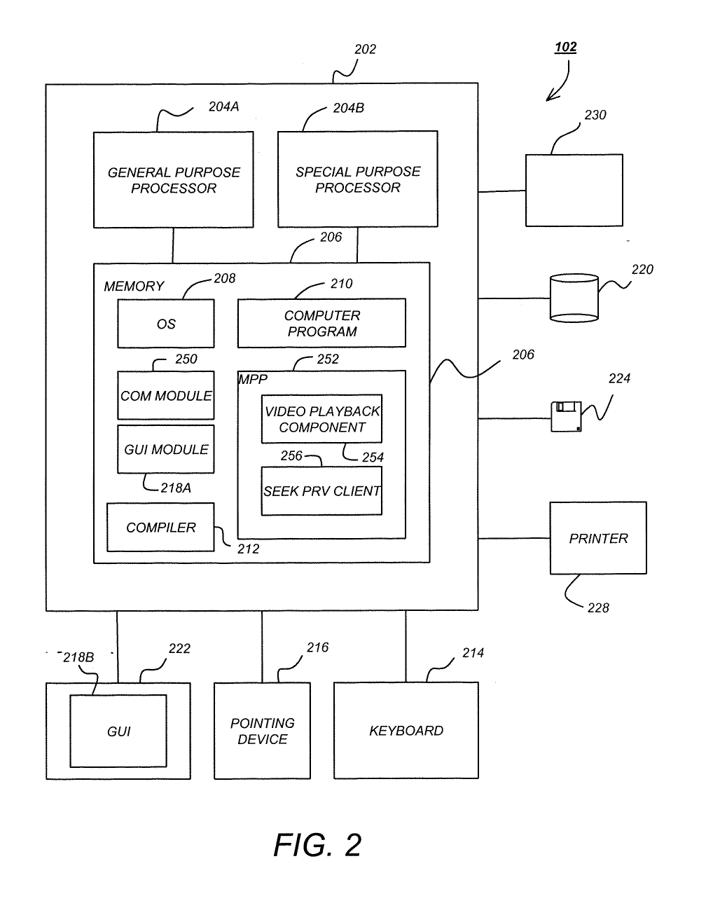

FIG. 2 illustrates an exemplary computer system 202 that could be used to implement elements the present invention, including the user computer 102, the media servers 112, 122 and/or the databases 114, 124. The computer 202 comprises a general purpose hardware processor 204A and/or a special purpose hardware processor 204B (hereinafter alternatively collectively referred to as processor(s) 204) and a memory 206, such as random access memory (RAM). The computer 202 may be coupled to other devices, including input/output (I/O) devices such as a keyboard 214, a mouse device 216 and a printer 228.

In one embodiment, the computer 202 operates by the general purpose processor 204A performing instructions defined by the computer program 210 under control of an operating system 208. The computer program 210 and/or the operating system 208 may be stored in the memory 206 and may interface with the user and/or other devices to accept input and commands and, based on such input and commands and the instructions defined by the computer program 210 and operating system 208 to provide output and results.

The computer system 202 also comprises a media program player (MPP) 252 having a video playback component 254 in communication with a seek preview client 256. The video playback component 254 of the MPP 252 receives the transmitted data comprising the media program, decodes, processes and renders the data so that the user 132 can view the media program on the display 222. The seek preview client 256 allows the user to select any frame of the received and buffered media program data without interrupting the playback of a media program, as described below.

Output/results may be presented on the display 222 or provided to another device for presentation or further processing or action. In one embodiment, the display 222 comprises display having a plurality of separately addressable picture elements such as pixels that change from one state to another to form an image that is presented to the user. In one embodiment, the display is a liquid crystal display (LCD) in which each liquid crystal changes to an opaque or translucent state to form a part of the image on the display in response to the data or information generated by the processor 204 from the application of the instructions of the computer program 210 and/or operating system 208 to the input and commands. The image may be provided through a graphical user interface (GUI) module 218A. Although the GUI module 218A is depicted as a separate module, the instructions performing the GUI functions can be resident or distributed in the operating system 208, the computer program 210, or implemented with special purpose memory and processors.

Some or all of the operations performed by the computer 202 according to the computer program 110 instructions may be implemented in a special purpose processor 204B. In this embodiment, the some or all of the computer program 210 instructions may be implemented via firmware instructions stored in a read only memory (ROM), a programmable read only memory (PROM) or flash memory in within the special purpose processor 204B or in memory 206. The special purpose processor 204B may also be hardwired through circuit design to perform some or all of the operations to implement the present invention. Further, the special purpose processor 204B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 202 may also implement a compiler 212 which allows an application program 210 written in a programming language such as COBOL, C++, FORTRAN, or other language to be translated into processor 204 readable code. After completion, the application or computer program 210 accesses and manipulates data accepted from I/O devices and stored in the memory 206 of the computer 202 using the relationships and logic that was generated using the compiler 212.

The computer 202 also optionally comprises an internal or external communication device or module (250, 230 respectively) such as a modem, satellite link, Ethernet card and/or accompanying software or other device for accepting input from and providing output to other computers as well as providing communications between software and/or hardware modules implemented in the computer 202.

In one embodiment, instructions implementing the operating system 208, the computer program 210, and the compiler 212 are tangibly embodied in a computer-readable medium, e.g., data storage device 220, which could include one or more fixed or removable data storage devices, such as a zip drive, floppy disc drive 224, hard drive, CD-ROM drive, tape drive, etc. Further, the operating system 208 and the computer program 210 are comprised of computer program instructions which, when accessed, read and executed by the computer 202, causes the computer 202 to perform the steps necessary to implement and/or use the present invention or to load the program of instructions into a memory, thus creating a special purpose data structure causing the computer to operate as a specially programmed computer executing the method steps described herein. Computer program 210 and/or operating instructions may also be tangibly embodied in memory 206 and/or data communications devices 230, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 202.

Although the term “user computer” is referred to herein, it is understood that a user computer 202 may include portable devices such as cellphones, portable MP3 players, video game consoles, notebook computers, pocket computers, or any other device with suitable processing, communication, and input/output capability.

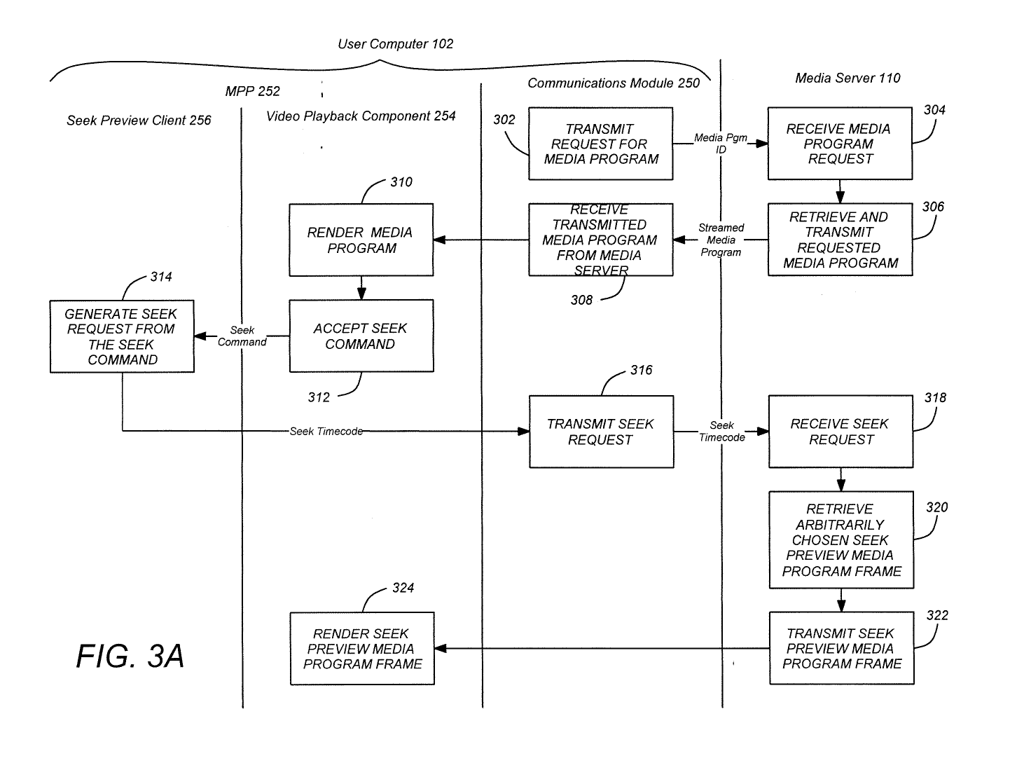

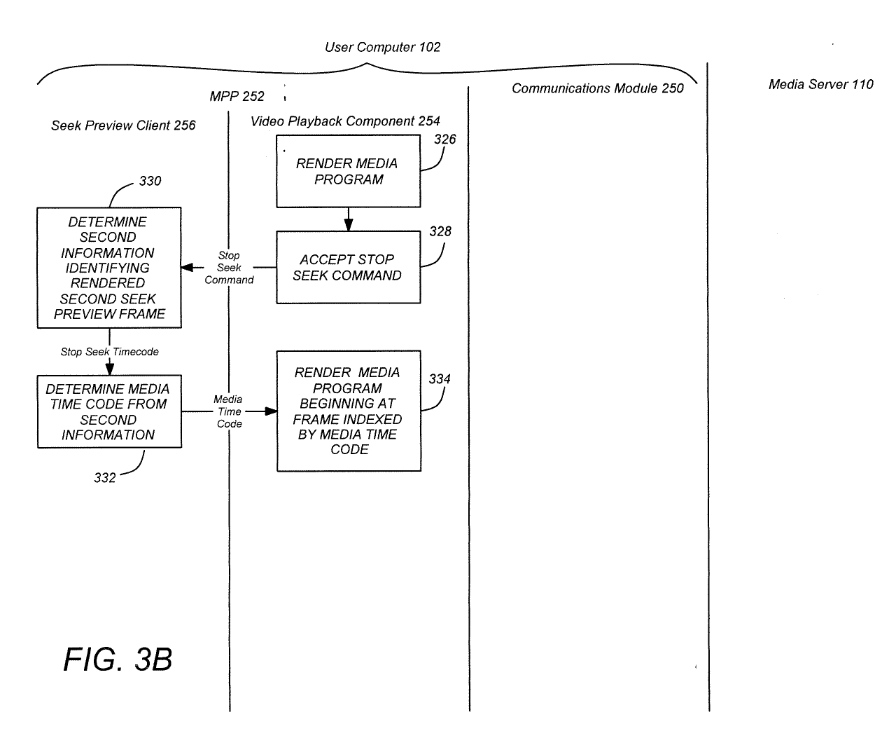

FIGS. 3A and 3B are diagrams presenting flowcharts illustrating exemplary operations that can be used to perform one embodiment of the invention. In block 302, a request for a media program is transmitted from the user computer 102 to the media server 110. The media program may be identified by a media program ID or other information. The media server 110 causes the media program to be retrieved and transmitted to the user computer 102, as shown in blocks 304 and 306. In one embodiment, this is accomplished by the media program 110 itself using media server 112 and database 114. In another embodiment, this is accomplished by the media server 110 providing the media program ID to one or more third party servers 120, which retrieve the media program and transmit it to the user computer.

In block 308, the media program is received by the user computer 102. The media program is then provided to a video playback component of a media program player (MPP) 254 implemented on the user computer. The video playback component 254 renders the media program, as shown in block 310 and transmits the rendered media program to the display 222 for presentation.

In block 312, the video playback component 254 accepts a seek command.

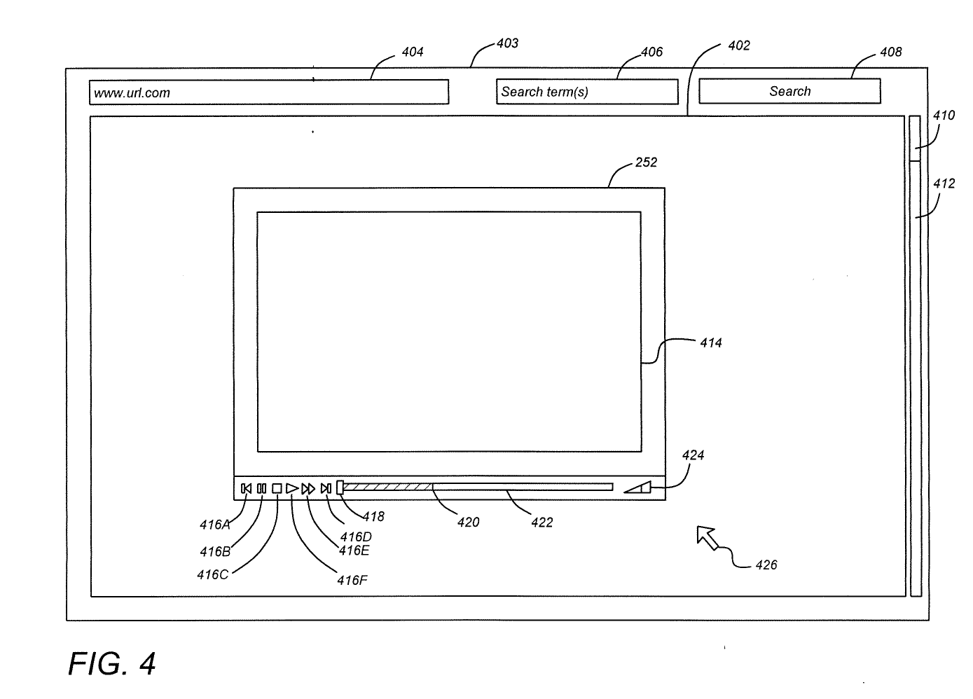

FIG. 4 is a diagram illustrating an exemplary user interface 402 presenting the MPP 252 on the display 222. In the illustrated embodiment, the MPP 252 is presented in a browser 403. The browser 403 may have an address box 404 where the user may enter the uniform resource locator (URL) of a website of interest. The browser 403 may also accept key words in a search box 406, and upon the selection of search button 408, provide a webpage with search results responsive to the search request to the user. Further, the information presented on the browser 403 may be viewed by using scroll bar 412 by selecting control 410 with the annunciator 426 and moving the control 410 along the scroll bar 412.

In one embodiment, the MPP 252 includes a view window 414 in which the media program is played back to the user, and a plurality of controls 416A-416F (hereinafter alternatively referred to as control(s) 416) which allow the playback of the media program to be controlled by the user. The controls 416 include a stop control 416C that is used to stop the playback of the media program, a play control 416F that is used to begin or resume playback of the media program and a pause control 416B that is used to pause playback of the media program. The controls 416 also include a fast forward control 416E that allow the user to fast forward through the media program, and a forward skip control 416D that allows the user to skip to the next scene or to the next media program. In one embodiment, next scene skipping can be selected by momentarily selecting the skip control 416D, while skipping to the next media program can be performed by selecting and holding the skip control 416D. Different scenes can be identified in the media program by use of markers indicating which frames begin a new scene or by the use of media program metadata identifying the frames for the first frame in each scene. Skip control 416A also allows skipping to the previous media program or scene, in the same way as skip control 416D.

In one embodiment, the MPP 252 may include a progress bar 422 that is rendered proximate the rendered media program in the view window 414. If the media program is progressively downloaded to the MPP 252, the progress bar 422 also may include a media buffer progress indicator 420 to indicate how much of the media program has been transmitted to the user computer 102 and buffered, and hence, how much of the media program might be available for seek previewing. Since streaming video permits the user to obtain access to different portions of the media program without buffering (e.g. through use of control signals transmitted to the media server 110 the media buffer progress indicator 420 is not required.

The control 418 indicates the temporal location of the frames currently being depicted by the MPP 252. The user may command the MPP 252 to replay any portion of the media program via control 418 manipulation by selecting the control 418 and moving the control 418 to a different location along the progress bar 422. Leftmost locations on the progress bar 422 indicate temporal locations near the beginning of the media program, while rightmost locations indicate temporal locations near the end of the media program.

Returning to FIG. 3A, the user enters a seek command by, for example, selecting control 418 from the current temporal location and moving it to another arbitrarily chosen temporal location within the media program. The seek preview client 256 generates a seek request from the seek command as shown in block 314 and transmits that seek request to the media server 110 via the communications module 250, as shown in block 316. In one embodiment, the seek request includes a seek timecode, the timecode identifying the seek preview frame of interest by indicating how much time would have elapsed between the beginning of the media program and the frame of interest, should the media program have been played back in real time. In one embodiment, the seek time code is determined from the duration (temporal length) of the media program and the location of the control 418 on the progress bar 422 relative to the beginning (in FIG. 4, the leftmost portion of the progress bar 422) of the progress bar and the end of the progress bar (in FIG. 4, the rightmost portion of the progress bar 422). For example, if the media program is 2.5 hours long, and the control 418 is equidistant between the beginning of the progress bar 422 and the end of the progress bar 422 (e.g. at the midpoint or 50% point of the media program), the seek time code may be determined as [2.5*50%] or 1.25 hours, or 01:15:00 or 011500.

The media server 110 receives the seek request, as shown in block 318, and uses the information in the seek request to retrieve a seek preview media program frame, as shown in block 320. In one embodiment, the seek preview media program frame has lower resolution than the media program. The selected seek preview media program frame is then transmitted or streamed to the user computer 102 for playback by the video playback component, as shown in block 322. The video playback component 254 of the MPP 252 then renders the seek preview media program frame, as shown in block 324 so that the state of the pixels in the display 222 are modified to present an image of the seek preview media program frame to the user.

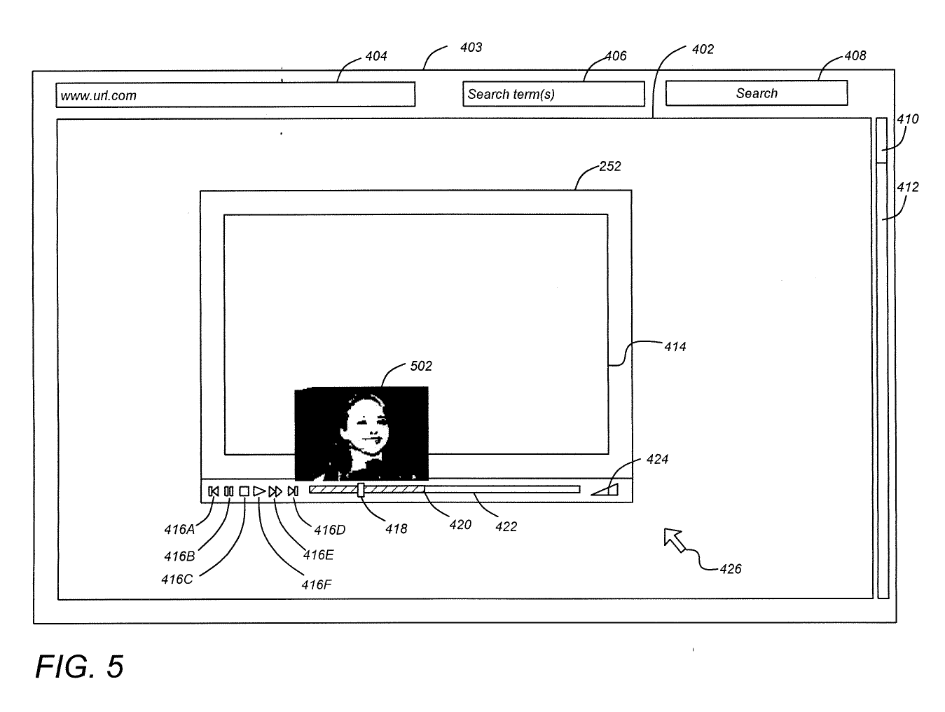

FIG. 5 is a diagram illustrating the exemplary user interface 402 after the user has moved the control 418 of the progress bar 422 to a second position temporally forward from the first position shown in FIG. 4. In the illustrated embodiment, the MPP 252 has rendered a thumbnail or smaller, low resolution version of the media program frame corresponding to the position of the control 418. In practice, as the control 418 is moved along the progress bar 422, a plurality of different seek requests are transmitted and a corresponding plurality of thumbnails, each corresponding to a version of the media program at the temporal location of the control 418 is rendered and presented to the user. Hence, as the user grabs the control 418 and moves it along the progress bar 422, a series of images are presented in the thumbnail 502, each corresponding a corresponding image in the media program. In one embodiment, this process occurs concurrently with the presentation of the media program itself in the view window 414. Hence, playback of the media program need not be interrupted or paused to use the seek-preview functionality.

In one embodiment, the foregoing is implemented by generating a plurality of thumbnails from the frames of the media program, each with lower resolution than the media program. In another embodiment, a seek preview version of the media program (e.g. the seek preview media program) is generated, each seek preview frame preferably being of lower resolution than the media program. The seek preview version of the media program used for the thumbnails may provided to the user computer 102 in a variety of ways. In an embodiment wherein the media program is downloaded to the user computer 102 in its entirety before the media program is rendered by the MPP 252, the seek preview version of the media program may be merely downloaded with the media program itself or separate from the media program, with each of the frames of the seek preview media program indexed to an associated frame of the media program depicting the same scene. In this embodiment, the seek preview version and the complete media program may be separate files. In an embodiment wherein the media program is progressively downloaded to the user computer 102, the seek preview version of the media program can be downloaded along with the media program, or may also be a separate file with appropriate indexing. In an embodiment wherein the media program is streamed to the user, the seek preview frames can be downloaded in advance when streaming media service begins, or may be transmitted to the user computer using the same two-way protocol used to stream the media itself. In this case, the frames of the seek preview version may be transmitted one at a time to the user computer upon request.

Since motion video need not be depicted, a thumbnail or seek preview frame need not be created or transmitted corresponding to each and every frame of the media program. Instead, thumbnails or seek preview frames need be generated only for a subset of the frames of the media program.

In an embodiment using MPEG encoding, the subset of frames for which thumbnails are created includes the I-frames of the MPEG program so as to allow smooth presentation of video from the selected point. In one embodiment, the thumbnail is presented adjacent or at least proximate the control 418, hence, the user's eye can see the control 418 and the thumbnail at the same time. In another embodiment, the control 418 takes on the appearance of the thumbnail 502 with the image when the control 418 is selected, and the thumbnail changes it's appearance as it is dragged across the progress bar 422.

Turning to FIG. 3B, while rendering the media program 326, the video playback component 254 of the MPP 252 accepts a stop seek command, as shown in blocks 326 and 328. In an embodiment where the seek command was entered by selecting the control 418 (e.g. by mousing over the control 418 and depressing a mouse button) and moving the control to the right along the progress bar 422 (e.g. while keeping the mouse button depressed), the stop seek command can comprise simply deselecting the control 418 (e.g. by releasing the mouse button). The stop seek command is then provided to seek preview client 256, which determines second information identifying the rendered second seek preview frame (e.g. the seek preview frame that was rendered when the stop seek command was received). In one embodiment, this information is a stop seek timecode, indicating the elapsed time since the beginning of the media program. This is shown in block 330. A media program timecode is then determined from the second information (e.g. the stop seek timecode), as shown in block 322. Next, as shown in block 334, the media program is rendered, beginning at the media program time frame indexed by the determined media program time code. For example, if the stop seek command is accepted when a seek preview media program frame has a timecode of 012533 has been rendered (indicating that the seek preview media program frame corresponds to a media program frame approximately one hour, twenty-five minutes and thirty-three seconds from the beginning of the media program), a media program timecode temporally at least proximate to the 012533 timecode is identified, and the media program is then played or rendered beginning at a frame having the determined timecode. Since the number of seek preview media program frames is typically fewer than those of the media program itself, a media program time code can typically be determined that is not only temporally proximate to the seek preview media program frame's timecode, but precisely the same timecode.

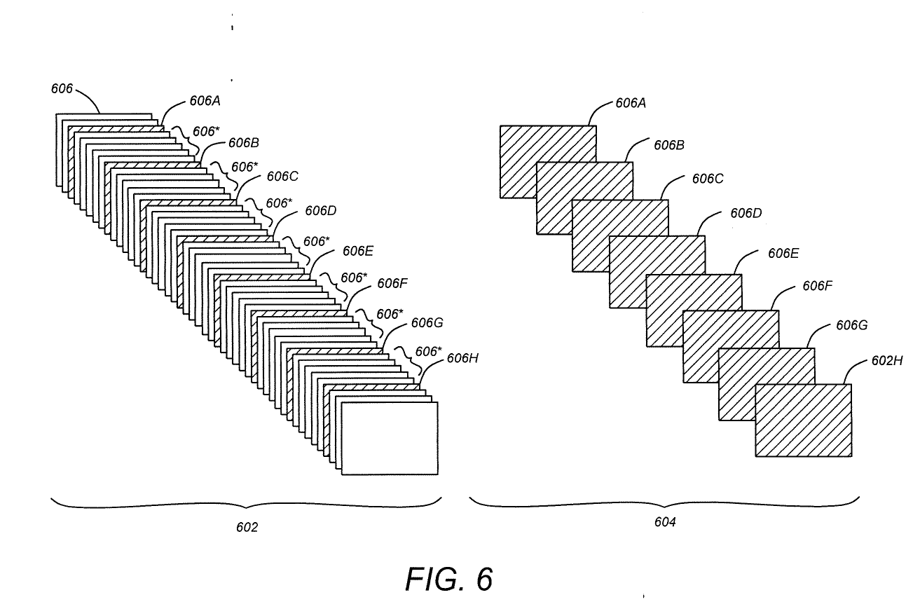

FIG. 6 is a diagram illustrating the media program 602 and the seek preview version of the media program 604. As shown, the media program 602 comprises a plurality of frames 606. The frames 606 include frames (606A-606H) that are selected for use in the seek preview media program 604. The although the seek preview media program frames 602A-602H are temporally equally spaced in FIG. 6, this need not be the case. Since there are typically fewer frames in the seek preview version of the media program, there is typically not a 1:1 correspondence between the stop seek timecode of the seek preview version of the media program. In such embodiments, the determined media program timecode is media program timecode that is closest to the stop seek timecode of the seek preview version of the media program. If MPEG encoding is used and it is necessary to begin playback at an I-frame, the temporally closest I-frame may be used.

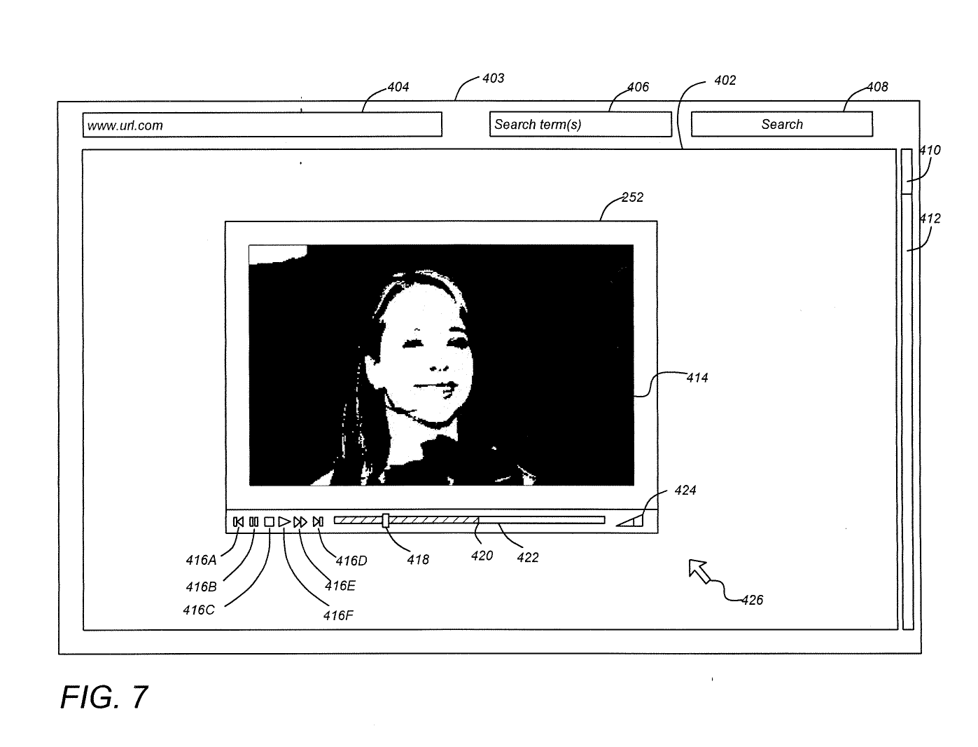

FIG. 7 is a diagram illustrating the exemplary user interface after the user has entered a stop seek command by releasing the mouse button. As shown, the thumbnail or frame of the seek preview media program 502 depicted in FIG. 5 is no longer rendered, but the media program frame associated with the frame of the seek preview media program 502 is not depicted, full resolution, and full size in the view window 414. Playback of the media program can automatically (without further user intervention) continue at this time beginning at the depicted media program frame and going forward. Or, alternatively, the playback of the media program may be paused at the depicted frame until the user selects the lay 416F control.

In one embodiment, the seek preview information (frames or thumbnails) are streamed or downloaded separately (for example, in a separate streaming thread) from the media program. Since the seek preview information is typically coarser (lower) resolution versions of media program frames, and typically includes only a subset of the media program frames, the seek preview information can be rapidly retrieved and/or streamed and presented. For progressive download embodiments, this has the advantage of allowing the user to preview any portion of the media program, even those which have not been buffered to the point of allowing full resolution frames of the media program to be presented. For example, in the embodiment shown in FIG. 5, it is possible for the control 418 to be manipulated past the media buffer progress indicator 420 and to have the appropriate frames of the seek preview media stream or thumbnail rendered next to the control 418. Further, as set forth more fully below, after the user has found a seek preview frame representing a portion of the media program of interest, the user may indicate as such by control manipulation, thus commanding the MPP 252 to begin the progressive downloading process anew from the temporal position within the media program nearest the temporal position of the selected seek preview frame.

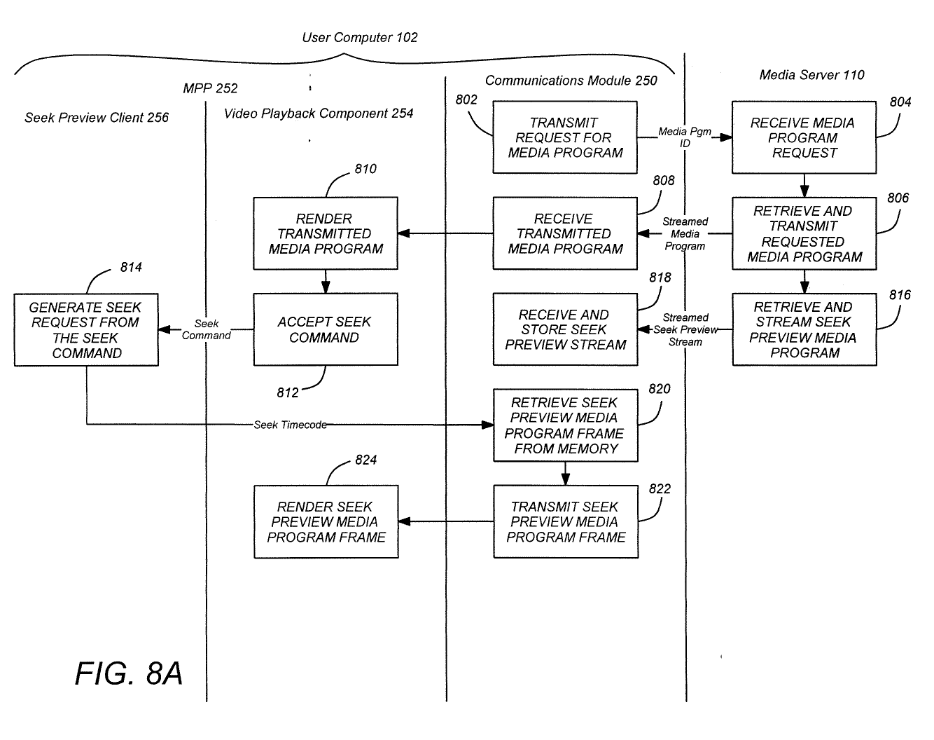

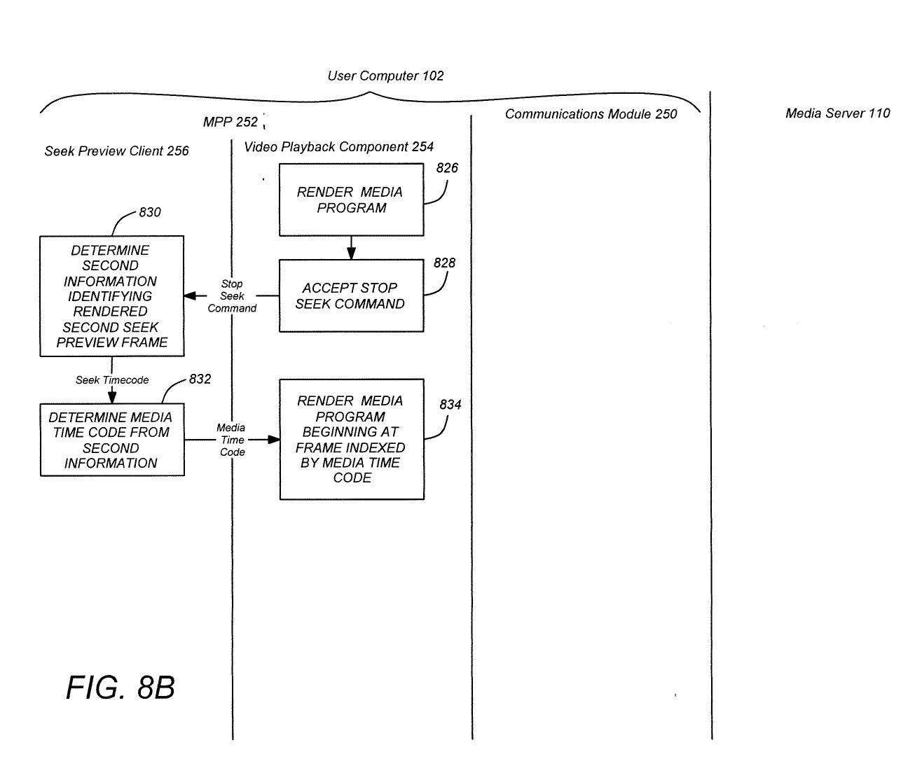

FIGS. 8A and 8B is a flowchart depicting another embodiment of the present invention. Unlike the embodiment illustrated in FIGS. 3A and 3B, in which seek request are transmitted external to the user computer 102 to retrieve the arbitrarily chosen seek preview media program frame, the embodiment illustrated in FIGS. 8A and 8B receive and store the seek preview stream in advance, and the seek preview frames are thereafter retrieved from the user computer memory 206. This embodiment has the advantage of a faster response time to user commands, and since the stored seek preview frames are low resolution versions of the media program frames (and typically represent only a subset of the media program frames), concerns regarding remote storage of the seek preview frames are of less concern than the remote storage of the media program itself. In this embodiment, steps 802-814 are analogous to steps 302-314 described above with reference to FIG. 3A. However, in this embodiment, while the media program is being transmitted to the user computer 102 as shown in block 806, a parallel process to retrieve and transmit a seek preview media program to the user computer 102 is initiated, as shown in block 816. The seek preview media program is received and stored in the user computer 102 memory 206, as shown in block 818 for future use, as described below.

A seek request is generated from a seek command accepted from the user, as shown in blocks 812 and 814. The seek request includes information such as a seek timecode that identifies the seek preview media program frame of interest. This information is transmitted to the communications module 250 of the user computer 102 which transmits the request to the appropriate user computer software and/or hardware elements to retrieve the identified seek preview media program frame from the memory 206, as shown in block 820. The retrieved seek preview media program frame is then transmitted to the video playback component via the communications module 250, as shown in block 822. The video playback component renders the see preview media program frame as shown in block 824. The result in the user interface 402 is the same as that which is illustrated in FIG. 5. As the user drags the control 418 across the progress bar 422, different seek preview frames are requested, retrieved, and provided for rendering without interrupting playback of the media program.

Turning to FIG. 8B, while the media program is being rendered (block 826) a stop seek command is accepted, as shown in block 828, using the same techniques described in connection with FIG. 3B. In block 830, second information is determined that identifies the seek preview frame that was rendered when the stop seek command was accepted. In one embodiment, this information comprises a seek timecode. In block 832, the seek timecode is used to determine the media time code temporally proximate the seek timecode. The media timecode identifies a media program frame temporally proximate the rendered seen preview media program frame. The media timecode is transmitted to the video playback component 254, which renders the media program beginning at the frame indexed by the media time code, as shown in block 834.

In any of the above embodiments, the seek preview media program frames may be generated in advance and stored for future use, or may be generated in real time or near real time in response to the user request for a seek preview frame.

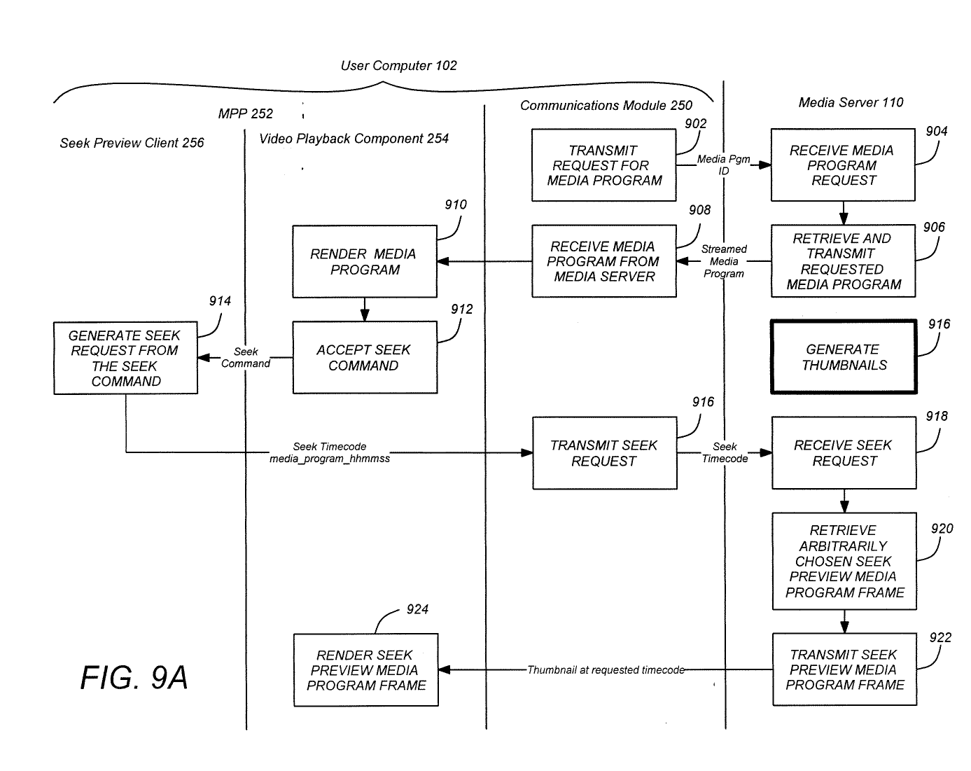

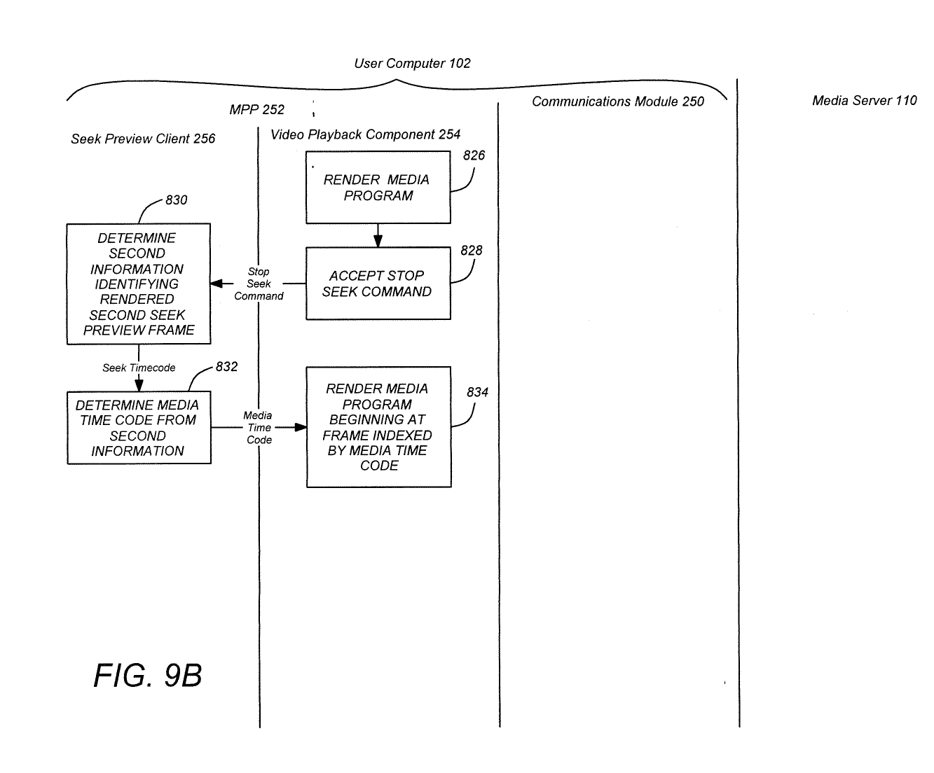

FIGS. 9A and 9B are diagrams depicting a flowchart of still another embodiment of the present invention. While the retrieval of a seek preview media program allows the seek preview functionality to be implemented with similar tools and protocols as those that are already in place for the streaming of the media program itself, the use of such tools and the streaming of the seek preview media program results in substantial delays in the presentation and rendering of the preview frames. The embodiment illustrated in FIGS. 9A and 9B reduces these delays because it does not rely on streaming protocols, but instead, uses pre-generated thumbnails of the media program, and indexes each pre-generated thumbnail so that it can be retrieved when necessary. In one embodiment, this is accomplished by including a “timecode” or similar value in the filename or in metadata for the thumbnail. As was true with other embodiments, thumbnails for only a subset of the media program frames need be generated, although thumbnails may be generated for all media program frames.

The operations performed by blocks 902-912 are analogous to the operations performed by blocks 302-312 and 802-812, as described above. However, before the seek command is accepted and the seek request received, thumbnails of the media program are generated as shown in block 916. The thumbnails can be generated well in advance (e.g. before the media program is requested or transmitted to the user computer 102) or can be generated after the user request for the media program, but before the seek request is received.

A seek command is accepted from the user, as shown in block 912. The seek command can be provided by the user via selecting the control 418 and moving the control 418 to another location on the progress bar 422, thus selecting an arbitrarily chosen seek preview media program frame. A seek request is generated from the seek command, as shown in block 914. The seek requests includes information identifying the thumbnail of interest. In one embodiment, each of the thumbnails generated in block 916 is provided a name that identifies the thumbnail in a way analogous to a timecode in that it identifies the temporal location of the thumbnail within the media program. For example, the thumbnails generated for the movie “Get Smart” may be generated with the filenames get_smart_{—}010223, representing that the thumbnail was generated from the media program frame found one hour, two minutes and twenty-three seconds from the beginning of the media program. The seek preview request having the information identifying the seek preview media program frame of interest is transmitted to the media server 110 as shown in block 916, and received as shown in block 918. Using the information, the media server 110 retrieves the thumbnail associated with the arbitrarily chosen seek preview media program frame, as shown in block 920 and transmits that thumbnail to the video playback component of the MPP 252 as shown in block 924. The result is analogous to that which is illustrated in FIG. 5.

In another embodiment, the thumbnails are generated and transmitted to the user computer 102 for storage and later retrieval. The thumbnails can be transmitted in parallel with the transmitted media program, for later retrieval internal to the user computer, thus providing a functionality similar to that which is depicted in FIG. 8A.

FIG. 9B is a diagram illustrating one embodiment of the operations performed when the user enters a stop seek command. The operations are analogous to those depicted and discussed in connection with FIGS. 3B and 8B.

### CONCLUSION

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching. For example, although the foregoing discussion has focused on the notion of providing a seek preview of a streamed or progressively downloaded media program, the same techniques can be used to provide the same functionality with a media program that is not streamed or progressively downloaded, but rather, downloaded completely before playback. Also, although the foregoing discussion describes a system wherein the seek preview media program frames are hosted by same entity as which provides the media program, this need not be the case. The media program and the seek preview media program or thumbnails can be provided by different entities, and may be provided by third party servers.

It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of playing a media program and providing a preview frame of the media program in response to a seek command, comprising the steps of:
(a) transmitting a request for the media program from a user computer to a media server, wherein the media program is selected from the group consisting of a streamed media program and a progressively downloaded media program;
(b) receiving the media program from the media server in the user computer, the media program having a plurality of media program frames indexed by a plurality of media program time codes;
(c) rendering the media program in a media program player (MPP) implemented by the user computer;
(d) accepting a seek command in the user computer;
(e) generating a seek request from the seek command, the seek request including information identifying an arbitrarily chosen seek preview media program frame associated with the media program;
(f) retrieving the arbitrarily chosen seek preview media program frame; and
(g) rendering the received arbitrarily chosen seek preview media program frame in the playback component of the MPP.

2. The method of claim 1, wherein:
step (c) is performed concurrently with steps (d)-(g).

3. The method of claim 2, further comprising the steps of:
accepting a second seek command in the user computer;
generating a second seek request from the second seek command, the second seek request including second information identifying an arbitrarily chosen second seek preview frame associated with the media program;
retrieving the arbitrarily chosen second seek preview frame; and
rendering the arbitrarily chosen second seek preview frame.

4. The method of claim 3, wherein the seek command and the second seek command are provided by user manipulation of a control of a progress bar rendered adjacent to the rendered media program and the arbitrarily chosen preview frame is rendered proximate the control of the progress bar.

5. The method of claim 4, wherein the media program comprises a duration, and the information identifying the arbitrarily chosen seek preview media program frame associated with the media program comprises a first seek time code generated by performing steps comprising the step of:
determining the first seek time code as from the duration and a location of the control of the progress bar relative to a beginning of the progress bar and an end of the progress bar.

6. The method of claim 1, further comprising the steps of:
accepting a stop seek command in the user computer;
determining second information identifying an arbitrarily chosen second seek preview frame associated with the media program, the arbitrarily chosen second seek preview frame rendered when the stop seek command is accepted in the user computer;
determining a media program time code from the second information; and
rendering the media program beginning at the media program frame indexed by the determined media program time code.

7. The method of claim 6, wherein:
the second information comprises a second seek time code the step of determining a media program time code from the second information comprises determining the media program time code temporally proximate the determined second seek time code.

8. The method of claim 1, wherein:
the media program comprises a plurality of media program frames and is associated with a seek preview media program, the seek preview media program comprising plurality of seek preview media program frames, each seek preview media program frame comprising a version of an associated one of the media program frames;
the seek request is transmitted from the user computer to the media server;
the information identifying the arbitrarily chosen seek preview media program frame associated with the media program comprises one of a plurality of seek time codes, each of the plurality of seek time codes associated with a seek preview frame of the seek preview media program; and
the arbitrarily chosen seek preview media program frame is retrieved from the media server using the one of a plurality of seek time codes;
the retrieved seek preview media program frame is transmitted to the user computer.

9. The method of claim 8, wherein the seek preview media program frames comprise coarser resolution versions of the associated media program frames, and wherein the plurality of seek preview media program frames are fewer in number than the plurality of media program frames.

10. The method of claim 1, wherein:
the media program comprises a plurality of media program frames and is associated with a seek preview media program, the seek preview media program comprising plurality of seek preview media program frames, each seek preview media program frame comprising a version of an associated one of the media program frames;
the method further comprises the steps of:
receiving at least a subset of the plurality of seek preview media program frames from the media server; before accepting the seek command in the user computer; and
storing the subset of the plurality of seek preview media program frames in a memory of the user computer; and
wherein the step of retrieving the arbitrarily chosen seek preview media program frame comprises the step of retrieving the arbitrarily chosen seek preview media program frame from the memory of the user computer using the information identifying the arbitrarily chosen seek preview media program frame.

11. The method of claim 10, wherein the seek preview media program frames comprise coarser resolution versions of the associated media program frames, and wherein the plurality of seek preview media program frames are fewer in number than the plurality of media program frames.

12. The method of claim 1, wherein:
the method further comprises the step of:
before receiving the request for the media program, generating a plurality of thumbnails from the plurality of media program frames, and indexing each of the plurality of generated thumbnails with a seek time code equivalent to the media time code of the media program frame from which the thumbnail was generated;
the seek request includes a seek time code identifying the generated thumbnail associated with the arbitrarily chosen seek preview media program frame; and
the retrieved arbitrarily chosen seek preview media program frame is the generated thumbnail having the seek time code.

13. The method of claim 12, wherein the filename of the generated thumbnails includes the seek time code associated with the thumbnail.

14. A method of concurrently playing a media program comprising a plurality of frames and providing a thumbnail of an arbitrarily chosen preview frame of the media program in response to a seek command, comprising the steps of:
(a) receiving a request for a media program in a media server from a user computer;
(b) transmitting the media program from the media server to the user computer, the media program for rendering in a media program player (MPP) implemented in the user computer and indexed by a plurality of media program time codes;
(c) receiving a seek request in the media server from a seek preview client implemented in the media program player, the seek request having at least one seek time code identifying the arbitrarily chosen seek preview media program frame of the media program; and
(d) transmitting the arbitrarily chosen preview frame to the user computer for rendering by the playback component of the MPP.

15. The method of claim 14, further comprising the steps of:
accepting a second seek request from the user computer, the second seek request including a second seek time code identifying an arbitrarily chosen second seek preview frame associated with the media program; and
transmitting the arbitrarily chosen second seek preview frame to the user computer for rendering by the playback component of the MPP.

16. The method of claim 15, wherein the seek command and the second seek command are provided by user manipulation of a control of a progress bar rendered adjacent to the rendered media program and the arbitrarily chosen preview frame is rendered proximate the control of the progress bar.

17. An apparatus for playing a media program and providing a preview frame of the media program in response to a seek command, comprising:
a user computer having a communications module communicatively coupled to a media program player (MPP) the communications module for:
transmitting a request for the media program from a user computer to a media server;
receiving the media program from the media server in the user computer, the media program having a plurality of media program frames indexed by a plurality of media program time codes;
and the media program player (MPP) for:
rendering the media program;
accepting a seek command in the user computer;
generating a seek request from the seek command, the seek request including information identifying an arbitrarily chosen seek preview media program frame associated with the media program;
retrieving the arbitrarily chosen seek preview media program frame; and
rendering the received arbitrarily chosen seek preview media program frame in the playback component of the MPP.

18. The apparatus of claim 17, wherein the media program player comprises:
a playback component for:
rendering the media program; and
rendering the received arbitrarily chosen seek preview media program frame in the playback component of the MPP.
a seek preview client, communicatively coupled to the playback component, for:
accepting a seek command in the user computer;
generating a seek request from the seek command, the seek request including information identifying an arbitrarily chosen seek preview media program frame associated with the media program;
retrieving the arbitrarily chosen seek preview media program frame.

19. The apparatus of claim 17, wherein the communications module and the MPP are implemented on a user computer comprising a processor communicatively coupled to a memory storing instructions for:
transmitting a request for the media program from a user computer to a media server;
receiving the media program from the media server in the user computer, the media program having a plurality of media program frames indexed by a plurality of media program time codes;
rendering the media program;
accepting a seek command in the user computer;
generating a seek request from the seek command, the seek request including information identifying an arbitrarily chosen seek preview media program frame associated with the media program;
retrieving the arbitrarily chosen seek preview media program frame; and
rendering the received arbitrarily chosen seek preview media program frame in the playback component of the MPP.

20. The apparatus of claim 17, wherein:
arbitrarily chosen seek preview media program frame is rendered concurrently with the media program.

21. The apparatus of claim 19, wherein the instructions further comprise instructions for:
accepting a second seek command in the user computer;
generating a second seek request from the second seek command, the second seek request including second information [a second seek time code] identifying an arbitrarily chosen second seek preview frame associated with the media program;
retrieving the arbitrarily chosen second seek preview frame; and
rendering the arbitrarily chosen second seek preview frame.

22. The apparatus of claim 21, wherein the seek command and the second seek command are provided by user manipulation of a control of a progress bar rendered adjacent to the rendered media program and the arbitrarily chosen preview frame is rendered proximate the control of the progress bar.

23. The apparatus of claim 22, wherein the media program comprises a duration, and the information identifying the arbitrarily chosen seek preview media program frame associated with the media program comprises a first seek time code generated by determining the first seek time code as from the duration and a location of the control of the progress bar relative to a beginning of the progress bar and an end of the progress bar.

24. The apparatus of claim 19, wherein the instructions further comprise instructions for:
accepting a stop seek command in the user computer;
determining second information identifying an arbitrarily chosen second seek preview frame associated with the media program, the arbitrarily chosen second seek preview frame rendered when the stop seek command is accepted in the user computer;
determining a media program time code from the second information; and
rendering the media program beginning at the media program frame indexed by the determined media program time code.

25. The apparatus of claim 24, wherein:
the second information comprises a second seek time code; and
the step of determining a media program time code from the second information comprises determining the media program time code temporally proximate the determined second seek time code.

26. The apparatus of claim 19, wherein:
the media program comprises a plurality of media program frames and is associated with a seek preview media program, the seek preview media program comprising plurality of seek preview media program frames, each seek preview media program frame comprising a version of an associated one of the media program frames;
the seek request is transmitted from the user computer to the media server;
the information identifying the arbitrarily chosen seek preview media program frame associated with the media program comprises one of a plurality of seek time codes, each of the plurality of seek time codes associated with a seek preview frame of the seek preview media program; and
the arbitrarily chosen seek preview media program frame is retrieved from the media server using the one of a plurality of seek time codes;
the retrieved seek preview media program frame is transmitted to the user computer.

27. The apparatus of claim 26, wherein the seek preview media program frames comprise coarser resolution versions of the associated media program frames, and wherein the plurality of seek preview media program frames are fewer in number than the plurality of media program frames.

28. The apparatus of claim 19, wherein:
the media program comprises a plurality of media program frames and is associated with a seek preview media program, the seek preview media program comprising plurality of seek preview media program frames, each seek preview media program frame comprising a version of an associated one of the media program frames;
the instructions further comprise instructions for:
receiving at least a subset of the plurality of seek preview media program frames from the media server; before accepting the seek command in the user computer; and
storing the subset of the plurality of seek preview media program frames in a memory of the user computer; and
wherein the instructions for retrieving the arbitrarily chosen seek preview media program frame comprises instructions for retrieving the arbitrarily chosen seek preview media program frame from the memory of the user computer using the information identifying the arbitrarily chosen seek preview media program frame.

29. The apparatus of claim 28, wherein the seek preview media program frames comprise coarser resolution versions of the associated media program frames, and wherein the plurality of seek preview media program frames are fewer in number than the plurality of media program frames.

30. An apparatus for concurrently playing a media program comprising a plurality of frames and providing a thumbnail of an arbitrarily chosen preview frame of the media program in response to a seek command, comprising:
a media server having processor communicatively coupled to a memory, the memory storing instructions comprising instructions for:
receiving a request for a media program in a media server from a user computer;
transmitting the media program from the media server to the user computer, the media program for rendering in a media program player (MPP) implemented in the user computer and indexed by a plurality of media program time codes;
receiving a seek request in the media server from a seek preview client implemented in the media program player, the seek request having at least one seek time code identifying the arbitrarily chosen seek preview media program frame of the media program; and
transmitting the arbitrarily chosen preview frame to the user computer for rendering by the playback component of the MPP.

31. The apparatus of claim 30, wherein the instructions further comprise instructions for:
accepting a second seek request from the user computer, the second seek request including a second seek time code identifying an arbitrarily chosen second seek preview frame associated with the media program;
transmitting the arbitrarily chosen second seek preview frame to the user computer for rendering by the playback component of the MPP.

32. The apparatus of claim 31, wherein the seek command and the second seek command are provided by user manipulation of a control of a progress bar rendered adjacent to the rendered media program and the arbitrarily chosen preview frame is rendered proximate the control of the progress bar.
